(19) United States
(12) Patent Application Publication
(10) Pub. No.: US 2019/0326608 A1
(43) Pub. Date: Oct. 24, 2019

(54) PALLADIUM OXIDE CATALYST FOR DIRECT FORMIC ACID FUEL CELL AND PREPARATION METHOD THEREOF

(71) Applicant: SOUTH CHINA UNIVERSITY OF TECHNOLOGY, Guangdong (CN)

(72) Inventors: Jianhuang ZENG, Guangdong (CN); Yangcheng JIANG, Guangdong (CN); Zhen LIU, Guangdong (CN); Shijun LIAO, Guangdong (CN)

(73) Assignee: SOUTH CHINA UNIVERSITY OF TECHNOLOGY, Guangdong (CN)

(21) Appl. No.: 16/466,642

(22) PCT Filed: Nov. 30, 2017
(86) PCT No.: PCT/CN2017/113795

§ 371 Date: Jun. 5, 2019

(30) Foreign Application Priority Data
Dec. 5, 2016 (CN) 201611101975.9

(51) Int. Cl. H01M 4/90; H01M 4/88; B01J 23/44; B01J 37/00; B01J 37/34

(52) U.S. Cl. CPC H01M 4/9016; H01M 4/8803; B01J 23/44; B01J 21/185; B01J 37/346; H01M 4/9083; B01J 37/009

(57) ABSTRACT

The present invention discloses a palladium oxide catalyst for a direct formic acid fuel cell and a preparation method thereof The preparation method is as follows: dissolving a palladium chloride to prepare an aqueous solution, adding a sodium citrate or a potassium citrate, adjusting the solution to a pH value ranging from 9 to 13; then, placing the above solution in a microwave reactor for microwave reaction for 3 minutes to 30 minutes, and refluxing and magnetically stirring simultaneously during the reaction to obtain a palladium oxide collid solution; after the palladium oxide colloid is cooled, adding a commercial carbon powder or a carbon nanotube to collect the palladium oxide; and performing suction filtration finally, washing a filter cake, drying the filter cake under vacuum, and grounding the filter cake to obtain a carbon-supported palladium oxide catalyst.

### TECHNICAL FIELD

The present invention belongs to the field of electrocatalysts for a direct formic acid fuel cell, and particularly relates to a palladium oxide catalyst for a direct formic acid fuel cell and a preparation method thereof.

### BACKGROUND

In fuel cells, electrocatalysts act as “factory” for electrochemical reactions, and are core materials in the cells. The development of electrocatalysts is one of the keys to fuel cells. Noble metals such as platinum, palladium, or platinum-palladium alloy have very high catalytic activity for oxidation reaction and oxygen reduction reaction of fuel molecules such as hydrogen, formic acid, methanol, ethanol, etc., so most commercial and practical electrocatalysts at present are carbon-supported platinum or carbon-supported palladium electrocatalysts. For an anode electrocatalyst for formic acid oxidation of direct formic acid fuel cells, a palladium catalyst or a carbon-supported palladium catalyst is recognized as the electrocatalyst with the best activity for formic acid oxidation. However, the formic acid oxidation activity of such catalyst still needs to be improved and the stability of the catalyst is poor.

Main purposes of preparing a palladium electrocatalyst by chemical reduction are small particle size and uniform particle size distribution, so as to maximize a specific surface area of the noble metal palladium and improve the utilization efficiency. In order to prepare a palladium with small particle size, a polymeric protective agent is usually added in the chemical reduction process to avoid particles from growing after nucleation. The disadvantage of this method is that if the polymeric protective agent is not removed before use, it will cover an active center of the palladium, making the catalytic activity ineffective. However, high temperature treatment is usually used to remove the polymeric protective agent, which will inevitably increase the particle size. There are many preparation methods for palladium electrocatalysts, and the most common one is ethylene glycol reduction. During the heating process, the ethylene glycol acts as both a protective agent and a reducing agent to reduce the palladium precursor to a palladium electrocatalyst. The electrocatalyst prepared by the method has a small particle size and is dispersed uniformly, but has the disadvantages of high energy consumption, oxidation of the ethylene glycol in the reaction process, incapability of recycling and high cost.

### SUMMARY

In order to solve the defects of the prior art, the present invention provides a noble metal electrocatalyst which has a low energy consumption for preparation, is simple, environmental friendly, rapid and low in cost and is easy to realize mass industrial production and a preparation method thereof, i.e., a palladium oxide catalyst for a direct formic acid fuel cell and a preparation method thereof. The most prominent technical feature of the present invention in comparison to other inventions is that the prepared electrocatalyst is a palladium oxide catalyst instead of a palladium catalyst.

The present invention is achieved by the following technical solutions.

A preparation method of a palladium oxide catalyst for a direct formic acid fuel cell comprises the following steps of:

(1) dissolving a water-soluble palladium precursor in water to prepare a palladium precursor solution, then adding a citrate, and adjusting the solution to a pH value ranging from 9 to 13 after complete dissolution;

(2) placing the solution obtained in the step (1) in a microwave reactor for microwave reaction, and refluxing by condensation water and magnetically stirring simultaneously to obtain a palladium oxide colloid solution;

(3) after the palladium oxide colloid solution is cooled, adding a carbon support to collect the palladium oxide colloid; and

(4) performing suction filtration on a mixed solution obtained in the step (3), and then cleaning a filter cake, drying the filter cake under vacuum, and grounding the filter cake to obtain a carbon-supported palladium oxide catalyst.

Preferably, the water-soluble palladium precursor in the step (1) is one of a palladium chloride, a sodium chloropalladate and a potassium chloropalladate.

Further preferably, the water-soluble palladium precursor is a palladium chloride.

Preferably, the citrate in the step (1) is a sodium citrate or a potassium citrate.

Preferably, a molar ratio of the citrate to the water-soluble palladium precursor in the step (1) is 5:1 to 0.5:1.

Preferably, the microwave reaction in the step (2) is conducted at a power ranging from 600 W to 1500 W, and lasts for 3 minutes to 30 minutes.

Preferably, the carbon support in the step (3) is a commercial carbon powder or a carbon nanotube.

Preferably, an addition amount of the carbon support in the step (3) accounts for 60 wt % to 90 w % of the palladium metal in the palladium oxide colloid.

The present invention also provides a palladium oxide catalyst for a direct formic acid fuel cell prepared by the preparation method above.

Preferably, a mass ratio of the palladium oxide in the palladium oxide catalyst is 10% to 40%.

The main principle of the present invention is that under alkaline conditions, the palladium precursor is hydrolyzed into palladium oxide particles under the protection of the citrate; as microwave is used for rapid heating, the hydrolysis speed is very fast, and the palladium oxide is generated by hydrolysis, which effectively avoids the autocatalytic effects of palladium, and realizes small particle size and is dispersed uniformly.

Compared with the prior art, the present invention has the following advantages and technical effects.

(1) According to the present invention, water is used as a solvent, which is green and environmentally friendly, and does not involve any organic substances in the whole process;

(2) without adding any high molecular weight protective agent, the catalyst does not require post-treatment after preparation;

(3) the invention has short reaction time and saves energy consumption;

(4) the electrocatalyst prepared by the present invention is palladium oxide instead of the usual palladium; and

(5) the electrocatalyst prepared by the present invention has a small particle size and is uniformly dispersed on a carrier.

### BRIEF DESCRIPTION OF THE DRAWINGS

FIG. 1 is a transmission electron microscope photograph of a palladium oxide colloid prepared in embodiment 1.

FIG. 2 is an x-ray diffraction diagram of the palladium oxide catalyst prepared in embodiment 1.

FIG. 3 is a cyclic voltammogram of a palladium oxide electrocatalyst in a solution of 0.5 mol L⁻¹ HCOOH+0.5 mol L⁻¹ H₂SO₄ at room temperature.

FIG. 4 is a cyclic voltammogram of a commercial palladium-carbon electrocatalyst in a solution of 0.5 mol L⁻¹ HCOOH+0.5 mol L⁻¹ H₂SO₄ at room temperature.

### DETAILED DESCRIPTION

The concrete implementation of the present invention is further described hereinafter with reference to the drawings and specific embodiments, but the embodiments are not intended to limit the present invention.

### Embodiment 1

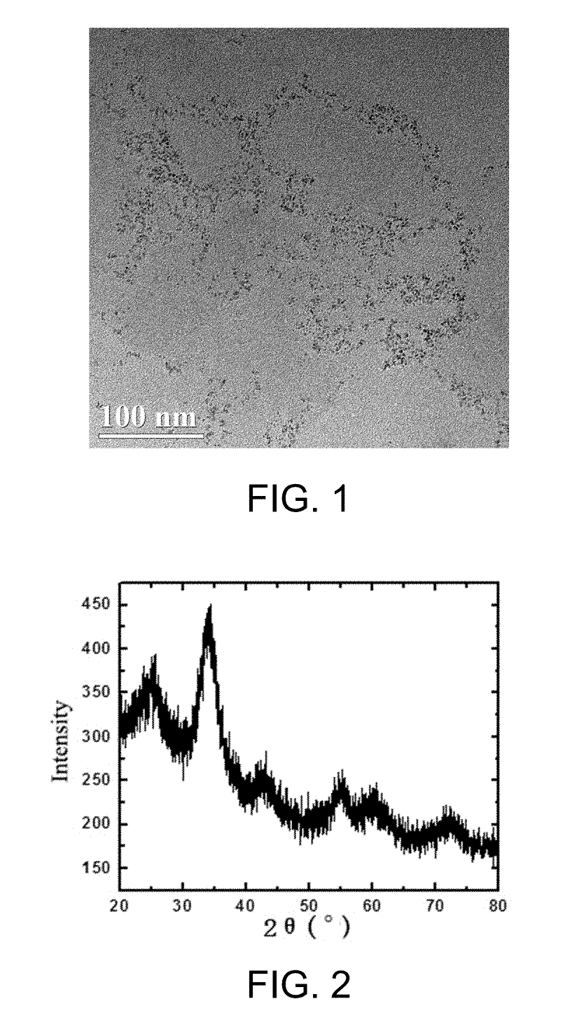

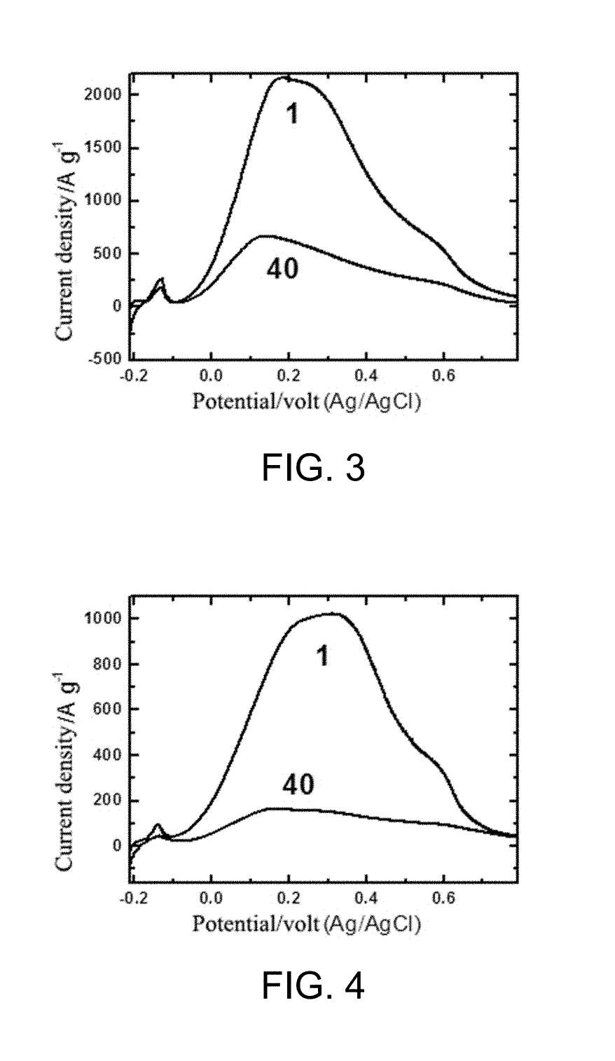

2.5 ml of prepared 0.12 mol L⁻¹ palladium chloride solution was added to 100 ml of water, followed by 1.5×10⁻³ mol of sodium citrate, and a molar ratio of the sodium citrate to the palladium chloride was 5:1; the solution was adjusted to a pH of 9; the solution was placed in a microwave reactor with a power of 1200 W for microwave reflux reaction for 17 minutes together with magnetically stirring to obtain a palladium oxide colloid solution; after the palladium oxide colloid solution was cooled, 120 mg of carbon powder was added to collect palladium oxide; and finally, suction filtration was performed, and then a filter cake was washed, dried under vacuum, and grounded to obtain a carbon-supported palladium oxide catalyst, and a mass ratio of palladium oxide in the palladium oxide catalyst was 20%. FIG. 1 is a transmission electron microscope photograph of the palladium oxide colloid prepared in the embodiment. As can be seen from FIG. 1, the palladium oxide has an average particle size of 2.5 nm, and is distributed uniformly. FIG. 2 is an x-ray diffraction diagram (XRD) of the palladium oxide catalyst prepared in the embodiment. A characteristic diffraction peak of the palladium oxide is apparent in FIG. 2. FIG. 3 is a cyclic voltammogram of a palladium oxide electrocatalyst in a solution of 0.5 mol L⁻¹ HCOOH+0.5 mol L⁻¹ H₂SO₄ at room temperature (numbers in the figure indicate the number of turns). A scanning speed is 20 mVs⁻¹. It can be seen from FIG. 3 that a peak current density of formic acid oxidation is 2172 Aeon the first turn, and after 40 turns, the current density is attenuated to 675 Ag⁻¹, which is attenuated by 69%. FIG. 4 is a cyclic voltammogram of a commercial palladium-catalyst catalyst in a solution of 0.5 mol L⁻¹ HCOOH+0.5 mol L⁻¹ H₂SO₄ at room temperature (numbers in the figure indicate the number of turns). A scanning speed is 20 mVs⁻¹. It can be seen from FIG. 4 that a peak current density of formic acid oxidation is 1022 Aeon the first turn, and after 40 turns, the current density is attenuated to 162 A g⁻¹, which is attenuated by 84%.

### Embodiment 2

2.5 ml of prepared 0.12 mol L⁻¹ palladium chloride solution was added to 100 ml of water, followed by 1.5×10⁻⁴ mol of sodium citrate, and a molar ratio of the sodium citrate to the palladium chloride was 0.5:1; the solution was adjusted to a pH of 13; the solution was placed in a microwave reactor with a power of 600 W for microwave reflux reaction for 30 minutes together with magnetically stirring to obtain a palladium oxide colloid solution; after the palladium oxide colloid solution was cooled, 47 mg of carbon nanotube was added to collect palladium oxide; and finally, suction filtration was performed, and then a filter cake was washed, dried under vacuum, and grounded to obtain a carbon-supported palladium oxide catalyst, and a mass ratio of palladium oxide in the palladium oxide catalyst was 40%. The average particle size of the palladium oxide prepared in the present embodiment is 2.2 nm, and the X-ray diffraction pattern shows that the catalyst prepared in the present embodiment is palladium oxide. The palladium oxide catalyst prepared by the present embodiment is in a solution of 0.5 mol L⁻¹ HCOOH+0.5 mol L⁻¹ H₂SO₄ at room temperature. A scanning speed is 20 mVs⁻¹, and a peak current density for formic acid oxidation on the first turn is 1600 A g⁻¹.

### Embodiment 3

4 ml of prepared 0.12 mol L⁻¹ palladium chloride solution was added to 100 ml of water, followed by 1.32×10⁻³ mol of sodium citrate, and a molar ratio of the sodium citrate to the palladium chloride was 2.75:1; the solution was adjusted to a pH of 11; the solution was placed in a microwave reactor with a power of 1500 W for microwave reflux reaction for 3 minutes together with magnetically stirring to obtain a palladium oxide colloid solution; after the palladium oxide colloid solution was cooled, 400 mg of carbon powder was added to collect palladium oxide; and finally, suction filtration was performed, and then a filter cake was washed, dried under vacuum, and grounded to obtain a carbon-supported palladium oxide catalyst, and a mass ratio of palladium oxide in the palladium oxide catalyst was 10%. The average particle size of the palladium oxide prepared in the embodiment is 2.3 nm. In a solution 0.5 mol L⁻¹ HCOOH+0.5 mol L⁻¹ H₂SO₄ at room temperature, a scanning speed is 20 mVs⁻¹, and a peak current density for formic acid oxidation of the palladium oxide catalyst prepared in the embodiment on the first turn is 1800 A g⁻¹.

1. A preparation method of a palladium oxide catalyst for a direct formic acid fuel cell, comprising the following steps of:
(1) dissolving a water-soluble palladium precursor in water to prepare a palladium precursor solution, then adding a citrate, and adjusting the solution to a pH value ranging from 9 to 13 after complete dissolution;
(2) placing the solution obtained in the step (1) in a microwave reactor for microwave reaction, and refluxing by condensation water and magnetically stirring simultaneously to obtain a palladium oxide colloid solution;
(3) after the palladium oxide colloid solution is cooled, adding a carbon support to collect the palladium oxide colloid; and
(4) performing suction filtration on a mixed solution obtained in the step (3), and then cleaning a filter cake, drying the filter cake under vacuum, and grounding the filter cake to obtain a carbon-supported palladium oxide catalyst.

2. The preparation method according to claim 1, wherein the water-soluble palladium precursor in the step (1) is one of a palladium chloride, a sodium chloropalladate and a potassium chloropalladate.

3. The preparation method according to claim 1, wherein the citrate in the step (1) is a sodium citrate or a potassium citrate.

4. The preparation method according to claim 1, wherein a molar ratio of the citrate to the water-soluble palladium precursor in the step (1) is 5:1 to 0.5:1.

5. The preparation method according to claim 1, wherein the microwave reaction in the step (2) is conducted at a power ranging from 600 W to 1500 W, and lasts for 3 minutes to 30 minutes.

6. The preparation method according to claim 1, wherein the carbon support in the step (3) is a commercial carbon powder or a carbon nanotube.

7. The preparation method according to claim 1, wherein an addition amount of the carbon support in the step (3) accounts for 60 wt % to 90 w % of the palladium metal in the palladium oxide colloid.

8. A palladium oxide catalyst for a direct formic acid fuel cell prepared by the preparation method according to claim 1.

9. The palladium oxide catalyst for a direct formic acid fuel cell according to claim 8, wherein a mass ratio of the palladium oxide in the palladium oxide catalyst ranges from 10% to 40%.

10. A palladium oxide catalyst for a direct formic acid fuel cell prepared by the preparation method according to claim 2.

11. A palladium oxide catalyst for a direct formic acid fuel cell prepared by the preparation method according to claim 3.

12. A palladium oxide catalyst for a direct formic acid fuel cell prepared by the preparation method according to claim 4.

13. A palladium oxide catalyst for a direct formic acid fuel cell prepared by the preparation method according to claim 5.

14. A palladium oxide catalyst for a direct formic acid fuel cell prepared by the preparation method according to claim 6.

15. A palladium oxide catalyst for a direct formic acid fuel cell prepared by the preparation method according to claim 7.

16. The palladium oxide catalyst for a direct formic acid fuel cell according to claim 10, wherein a mass ratio of the palladium oxide in the palladium oxide catalyst ranges from 10% to 40%.

17. The palladium oxide catalyst for a direct formic acid fuel cell according to claim 11, wherein a mass ratio of the palladium oxide in the palladium oxide catalyst ranges from 10% to 40%.

18. The palladium oxide catalyst for a direct formic acid fuel cell according to claim 12, wherein a mass ratio of the palladium oxide in the palladium oxide catalyst ranges from 10% to 40%.

19. The palladium oxide catalyst for a direct formic acid fuel cell according to claim 13, wherein a mass ratio of the palladium oxide in the palladium oxide catalyst ranges from 10% to 40%.

20. The palladium oxide catalyst for a direct formic acid fuel cell according to claim 14, wherein a mass ratio of the palladium oxide in the palladium oxide catalyst ranges from 10% to 40%.

21. The palladium oxide catalyst for a direct formic acid fuel cell according to claim 15, wherein a mass ratio of the palladium oxide in the palladium oxide catalyst ranges from 10% to 40%.
